(19) United States
(12) Patent Application Publication
(10) Pub. No.: US 2013/0006701 A1
(43) Pub. Date: Jan. 3, 2013

(54) ASSESSING AND MANAGING RISKS OF SERVICE RELATED CHANGES BASED ON DYNAMIC CONTEXT INFORMATION

(75) Inventors: Sinem Guven, Hawthorne, NY (US); Mark A. Thomas, Portsmouth (GB)

(73) Assignee: International Business Machines Corporation, Armonk, NY (US)

(21) Appl. No.: 13/175,275

(22) Filed: Jul. 1, 2011

(51) Int. Cl. G06Q 10/00; G06N 5/04

(52) U.S. Cl. 705/7.28

(57) ABSTRACT

A method of assessing and mitigating a risk of a proposed change includes entering a category of the change, filtering risk assessment questions based on the entered category of the proposed change, determining an initial risk based on a dynamic change context, determining at least one high risk factor that is associated with the initial risk, filtering mitigation risk questions based on the at least one high risk factors, and re-determining the risk from mitigation answers to the filtered mitigation risk questions.

### BACKGROUND

1. Technical Field

The present disclosure generally relates to assessing and managing risks, and more particularly to accessing and managing risks associated with computer service related changes.

2. Discussion of Related Art

Client may delegate the management of their Information Technology (IT) services and infrastructure to a service provider that specializes in the client's business. The client expects stability and high availability of their services at all times. However, in time, every client's infrastructure needs certain changes and upgrades in order to function effectively.

The Information Technology Infrastructure Library (ITIL) is a set of concepts and practices for Information Technology Services Management (ITSM), Information Technology (IT) development and IT operations. ITIL gives detailed descriptions of a number of important IT practices and provides comprehensive checklists, tasks and procedures that any IT organization can tailor to its needs. ITIL may be adopted by service providers to ensure efficient, prompt and accurate service management through standard processes.

Within ITIL, Change Management (CM) addresses the implementation of changes, required externally by the client or internally by the service provider, to ensure proper and continued functioning of the client's infrastructure. However, when an implemented change fails, it incurs a significant cost on the service provider to re-implement such changes and manage the impact of the failure. An effective change management process can help to ensure that risks associated with changes are assessed in a systematic fashion, and the high risk factors are mitigated early in the process to avoid change failures.

Depending on the client's infrastructure and requirements, service providers typically use a help desk model or client-specific model. In the help desk model, a help desk agent raises the change, and passes it to a technically competent Change Requester (CR) to complete the change documentation and assess its risk. In the client-specific model, the technically competent CR, through specialized knowledge of the client's account, raises the change and assesses its risk during documentation. Once the change is raised, it can be passed to a Change Manager (CM) for evaluation. The CM reviews the change, assesses its impact, discusses it with a Change Advisory Board if the risk is high, and schedules the changes upon approval.

In a risk categorization approach, the CR reviews the change at documentation time and selects the most applicable risk category from a well-defined list of available categories. The selection may be performed manually by considering all aspects of the change or through a more systematic risk assessment questionnaire. The questionnaire may be adopted from an IT risk assessment model, which calculates the risk of change by applying weights to each answer to yield a risk rating.

Assessment of the risk caused by a potential change relies heavily on one person's opinion, e.g., the CR. However, the CR may not understand the technical complexities of the change. Accordingly, incorrectly assessed change records may be created at the documentation phase, which may lead to incorrect risk categorization. Although the CM checks the integrity of the risk assessment during change evaluation, an incorrectly categorized change can skip the necessary level of scrutiny. For example, a high risk change incorrectly categorized as a low risk change could go through implementation without needing approval and result in an outage for a client. As another example, a low risk change incorrectly categorized as a high risk change could be unnecessarily pending in the approval queue, even though the client urgently needs the change.

Further, evidence suggests that manual risk assessment of changes is associated with increased failure rates when these changes are implemented. Further, because manual risk assessment is not a systematic approach, there is no guarantee that the CR will always categorize the same type of change under the same category unless they are very experienced with that type of change and take the time to consider all factors associated with the change.

A more systematic approach is the questionnaire approach, where the CR answers a static set of risk assessment questions to gather information about the change, and calculates the risk of change using weights applied to the answers. For example, a higher weight could be associated with a higher risk and a lower weight could be associated with a lower risk. While such risk assessment questions are carefully designed by Subject Matter Experts to determine the probability and the impact of a failure due to a potential change, the static nature of these questions prevents them being applicable to all kinds of requested changes. Further risk mitigation is typically an after-thought, which is planned on-demand and difficult to manage.

### BRIEF SUMMARY

According to an exemplary embodiment of the invention, a method of determining risk associated with a proposed change includes entering change information related to the proposed change and a category of the change, filtering risk assessment questions based on the entered category of the proposed change, asking at least one of the filtered risk assessment questions to generate first answers, automatically inferring second answers of at least one of the risk assessment questions based on the entered change information and historical information, and determining the risk from weights assigned to each answer.

According to an exemplary embodiment of the invention, a method of mitigating a risk associated with a proposed change includes determining at least one high risk factor that is associated with a determined risk of a proposed change, filtering mitigation risk questions based on the at least one high risk factors, asking the filtered mitigation risk questions to generate mitigation answers, and determining a reduced risk from the mitigation answers and a change context of the proposed change.

According to an exemplary embodiment of the invention, an apparatus for assessing and mitigating risk of a proposed change includes a memory storing a computer program to assess and mitigate risk, risk assessment questions, risk mitigation questions, and historical information associated with changes, and a processor configured to execute the computer program. The computer program is configured to prompt entry of change information related to the proposed change and a category of the change, filter the risk assessment questions based on the entered category, prompt for first answers to at least one of the filtered risk assessment questions, infer second answers to at least one of the filtered risk assessment questions based on the change information and historical information, determine a risk based on the first and second answers, and mitigate the risk based on the risk mitigation questions.

According to an exemplary embodiment of the invention, a method of assessing and mitigating a risk of a proposed change includes entering change information related to the change as well as a category of the change, filtering risk assessment questions based on the entered category of the proposed change, determining an initial risk based on answers to the filtered questions, determining at least one high risk factor that is associated with the initial risk, filtering mitigation risk questions based on the at least one high risk factors, and re-determining the risk from mitigation answers to the filtered mitigation risk questions.

### BRIEF DESCRIPTION OF THE SEVERAL VIEWS OF THE DRAWINGS

Exemplary embodiments of the disclosure can be understood in more detail from the following descriptions taken in conjunction with the accompanying drawings in which:

FIG. 1 illustrates a method for determining a risk of a proposed change according to an exemplary embodiment of the disclosure.

FIG. 2 illustrates a method for assessing risk of a proposed change according to an exemplary embodiment of the disclosure.

FIG. 3 illustrates a method for mitigating a determined risk of a proposed change according to an exemplary embodiment of the disclosure.

FIG. 4 illustrates an exemplary change category tree that may be used in conjunction with the method of FIG. 1 according to an exemplary embodiment of the disclosure.

FIG. 5 illustrates a risk assessment and mitigation system (engine) according to an exemplary embodiment of the disclosure.

FIG. 6 illustrates an example of a window that may be presented to mitigate a risk associated with a change.

FIG. 7 shows an example of a computer system capable of implementing the methods and systems according to embodiments of the disclosure.

### DETAILED DESCRIPTION

Exemplary embodiments of the disclosure relate to a real time risk assessment and mitigation engine, which can dynamically assess and manage risks based on the context of proposed changes. The context of a proposed change may refer to various aspects, attributes, and information surrounding a change, which may vary significantly from one change to another. For example, these aspects may be technical, environmental, communication, people, client-related, etc. In practice, a large amount of contextual information may be associated with each proposed change. This information can be used to increase the accuracy and reliability of risk assessment. Having a rich dynamically determined context for a proposed change enables risks to be caught early and mitigated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

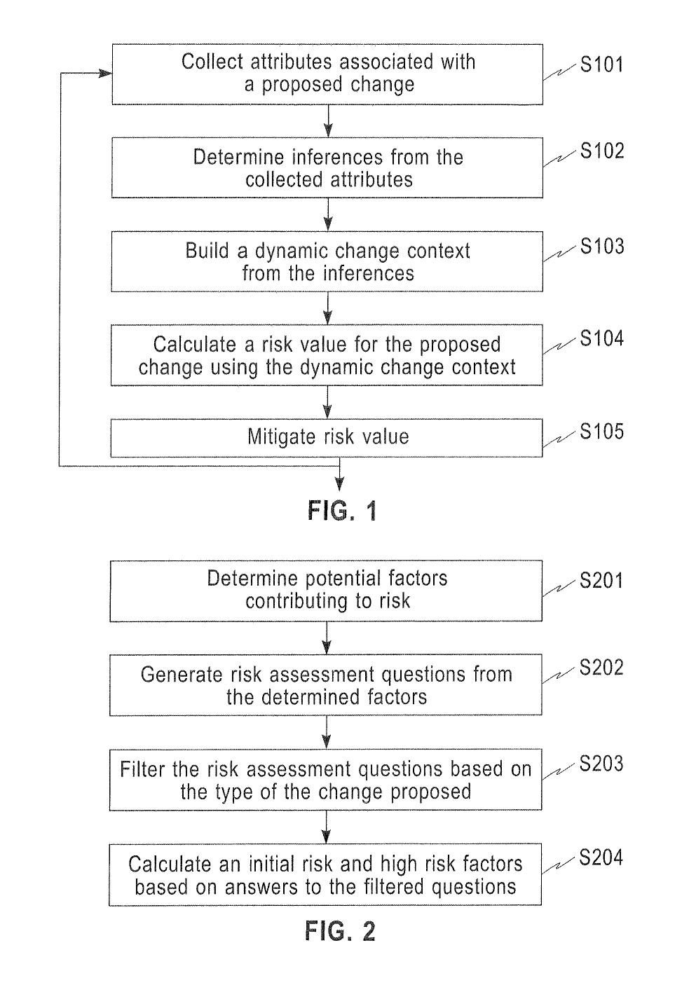

FIG. 1 illustrates a method of assessing and mitigating a risk of a proposed change according to an exemplary embodiment of the disclosure. Referring to FIG. 1, the method includes generating a dynamic change context associated with a proposed change, determining a risk value from the dynamic change context (S104), mitigating the risk value if possible (S105), and refining the dynamic change context to re-determine the risk value if needed. The dynamic change context may be generated by collecting attributes associated with the proposed change (S101), determining inferences based on the collected attributes (S102), and building the dynamic change context based on the determined inferences (S103).

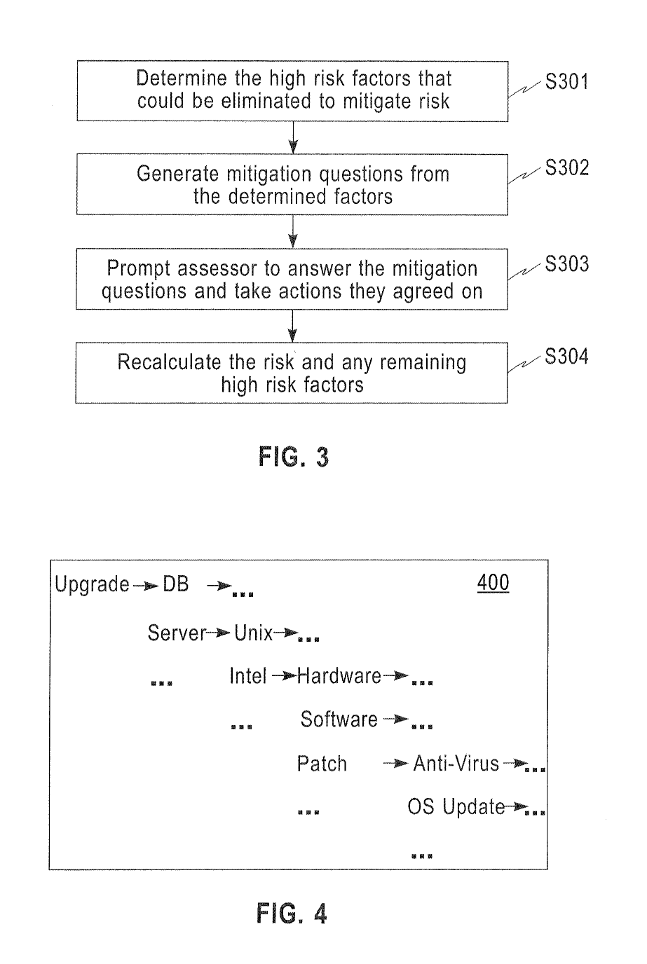

FIG. 2 illustrates a method of assessing a risk according to an exemplary embodiment of the disclosure that may be used to determine the risk value of FIG. 1. FIG. 3 illustrates a method of mitigating an assessed risk according to an exemplary embodiment of the disclosure that may be used to mitigate the determined risk value of FIG. 1. The methods of FIG. 2 and FIG. 3 may be used sequentially or independently of one another. Referring to FIG. 2, the method includes determining potential factors that contribute to the risk of making a change (S201). These factors may include technical complexity factors, dispersal of knowledge factors, environmental complexity factors, communication gap complexities. An example of a technical complexity factor is knowledge that an operating system upgrade is known to require several complex steps be performed by someone with specialized technical expertise. An example of a dispersal of knowledge factor is that the operating system upgrade requires these steps be performed by several individuals. An example of an environmental complexity is knowledge that the upgrade can only be performed during certain hours (e.g., 3 am-4 am). The determined factors are for types or categories of proposed changes. For example, as discussed above, the change may be upgrading an operating system. However, embodiments of the invention are not limited thereto. For example, the change categories/types may include upgrading/updating a database, upgrading a compiler, making changes to a computer program/documents, installing a patch, installing/upgrading a computer program, etc.

Referring back to FIG. 2, the method next includes determining risk assessment questions from the determined factors (S202). For example, if one of the technical factors—requires several experts—then the risk assessment question could be “does this change require several experts?”. For example, if one of the environmental factors is—highly constrained timeframe—, then the risk assessment question could be “does this change need to be implemented in a highly constrained timeframe?”. The risk assessment questions are designed to help predict either the probability or the impact of a failed change.

A risk weight may be assigned to each possible answer to a risk assessment question. These risk weight may be initialized by a subject matter expert. Additionally or alternately, the risk weight can be inferred from facts and historical information. For example, if changes that need to be implemented in a highly constrained timeframe historically result in a 30% failure rate and changes that need to be implemented by a multitude of experts result in a 40% failure rate, the changes could be assigned a risk weight that is proportional to their corresponding historical failure rates.

The risk weights may also be assigned by performing data mining or pattern matching algorithms on outputs generated from previous similar changes. For example, if upgrading an OS results in a log being produced, that log can be searched for patterns that lead a pattern matching algorithm to infer that the upgrade has failed.

Further, the risk assessment questions need not be yes/no questions. For example, if one of the technical factors is “requires experts”, the risk assessment question could provide choices, such as “does the change require a single expert, a few experts, or a multitude of experts”, where a risk weight could be assigned to each answer choice. For example, if a change requires a single expert, it could be weighted lower than a change that requires multiple experts.

Referring back to FIG. 2, the method further includes filtering the risk assessment questions based on the type or category of the change proposed (S203). For example, a multitude of risk assessment questions could have been produced by the previous step, where some of these are only valid for one category of change. In an alternate embodiment of the invention, the filtering is further based on the role of the individual that is assessing the risk. For example, depending on the phase of review, the assessor may be a change requestor, a change manager, a change approver, a change implementer, etc. The types of changes can be general changes or specific changes. An example of a general type of change could be “upgrade an operating system”, whereas an example of a specific type of change could be “upgrade the UNIX operating system”. For example, if someone selects “upgrade the operating system” as opposed to “upgrade the database”, only those risk assessment questions that are intimately related to upgrading an OS would be left by the filtering. Further, if the change selection is more specific, such as “upgrade the operating system to UNIX”, then the filtering would leave only those risk assessment questions that are intimately related to upgrading UNIX. For example, risk assessment questions related to upgrading all other operating systems would be filtered out. A subject matter expert can be used to initially map each risk assessment question to its appropriate type/category to allow this filtering to take place.

Referring back to FIG. 2, the method further includes determining an initial risk based on the answers to the filtered questions (S204). For example, as discussed above, a weight can be applied to each answer. These weights can be summed to arrive at an overall risk. The overall risk can be assigned a risk rating. The risk rating may be a numerical value (e.g., 1 for BAU, 2 for minor, 3 for medium, 4 for major, 5 for critical, etc.). While five risk ratings are discussed above, embodiments of the invention are not limited thereto, as a fewer or greater number of risking ratings may be present. The step of determining the initial risk may also provide a list of high risk factors associated with the change. For example, if a proposed change upgrading an operating system is associated with a factor that the change must be performed by a multitude of experts and a factor that the change must be performed within a highly constrained timeframe, and theses factors are considered highly risk (e.g., they are above a predefined risk threshold), as compared to other factors associated with the change, these highly risk factors can also be identified in addition to the initial risk.

FIG. 3 illustrates a method that may be used to mitigate the initially determined risk using the determined high risk factors according to an exemplary embodiment of the invention. For example, referring to FIG. 3, the method includes determining the high risk factors that can be eliminated to reduce the risk (S301). For example, a subject matter expert may have previously determined that the factor of “must be performed in a highly constrained timeframe” can be mitigated by performing the change in stages so that each part of the change has enough time to finish in the allotted timeframe. Referring back to FIG. 3, the method next includes generating mitigations questions from the determined high risk factors (S302). For example, if it is determined that a factor of a “highly constrained timeframe” can be mitigated, then the mitigation question could be “can the change be broken into stages?”. Next referring back to FIG. 3, the method includes prompting the assessor to answer the mitigation questions and take the necessary actions they agreed on to reduce risk (S303). For example, if the user agreed to take an action item, the system will prompt them to do so before the risk can be reduced. For example, if a back-out plan is missing and the user indicated while answering the mitigation questions that they agree to put in a back-out plan, the system will prompt them to enter a back-out plan and may not proceed until this is done. Referring back to the FIG. 3, the method may include a re-determination of the risk and remaining high risk factors (S204). For example, assume that the initially determined risk is considered a 5, and after the back-out plan has been added it is reclassified a 4. Further, any remaining high risk factors can be presented.

As discussed above with respect to FIG. 2, the generated risk assessment questions are filtered based on the category or type of the proposed change. A risk engine that performs this filtering has a mapping between change categories to risk questions to support such filtering. This filtering may be more efficient if the mapping is done with a high level of granularity. For example, the mapping could differentiate between “UNIX upgrades” vs. “intel upgrades” as opposed to bucketing both under “server upgrades”. Without this level of granularity, the Risk engine might ask the same set of risk assessment questions for both the UNIX and INTEL changes as it would not be able to differentiate between them. At least one embodiment of the invention uses a very finely granular change category tree to map change categories to risk questions. FIG. 4 shows an example of a change category tree 400 according to an exemplary embodiment of the invention. For example, the tree 400 includes a root node that relates to changes responsible for upgrading that has child nodes for upgrading a database DB and upgrading a server. Further, the server node has child nodes specifying that the upgrade can be for UNIX or INTEL. Further, the INTEL node has child nodes specifying that the Intel upgrade is a Hardware upgrade, a Software upgrade, or a Patch upgrade. Moreover, the Patch upgrade node has child nodes specifying that the Intel Patch upgrade can be an Anti-virus update or an Operating System OS update. The entered category or type may be linked to a branch series of directions so that the tree 400 can be traversed until an appropriate leaf node is reached that is linked to a specific set of risk assessment questions. For example, if the category is “Upgrade->Server->Intel->Patch->Anti-Virus” then the category could be linked with directions of right, left, 2 lefts, and right so that the desired leaf node can be reached by traversing from the root node of the tree 400 according to the branch directions in series. The category may also be selected in a graphical manner by presenting the tree 400 to the user and allowing them to graphically traverse the tree node by node until the desired leaf node is selected. FIG. 4 is merely an example of a category tree 400 that may be used and embodiments of the invention are not limited thereto.

As discussed above with respect to FIG. 2, the initial risk is determined based on the answers to the filtered questions. In an alternate embodiment of the invention, inferences are determined based on the answers to the filtered questions, change record facts (e.g., change has a high urgency), account failure rates (e.g., changes performed in this account fail at a 1% rate) and account health information (e.g., missed 2 Service Level Agreements SLAB). These inferences define a change context dynamically and uniquely for each change record, and may be later used as a basis for determining and, if needed, mitigating the risk rating. Strengthening the change context in this manner ensures that the risk assessment does not rely on one person's opinion, and that it considers a larger set of factors when determining risk, thereby increasing accuracy and reliability.

Examples of these inferences include inferring scheduling conflicts, inferring whether the change is a model change, inferring whether a particular change implementer implemented a similar change before, inferring whether a particular change implementer has the right skill set to implement this change, inferring dependencies on other changes, inferring the impact of the change on a shared infrastructure, etc. The scheduling conflicts can be inferred by accessing a change calendar that lists dates for scheduling a series of changes. Whether a change is a model change can be inferred from accessing a model change library. Whether a similar such change has been implemented before by the same change implementer can be inferred from accessing a log or a database that archives the individuals that have made each change and the type of change. Whether a change implementer has the requisite skill to implement a change can be inferred from accessing a skill set table or library that lists the skills of change implementers and referring to a mapping between the skills and the proposed change. Whether the proposed change is dependent on other changes or is likely to impact a shared infrastructure could be inferred using a change management tool. However, embodiments of the invention are not limited to the above provided inferences, as various other inferences may be generated.

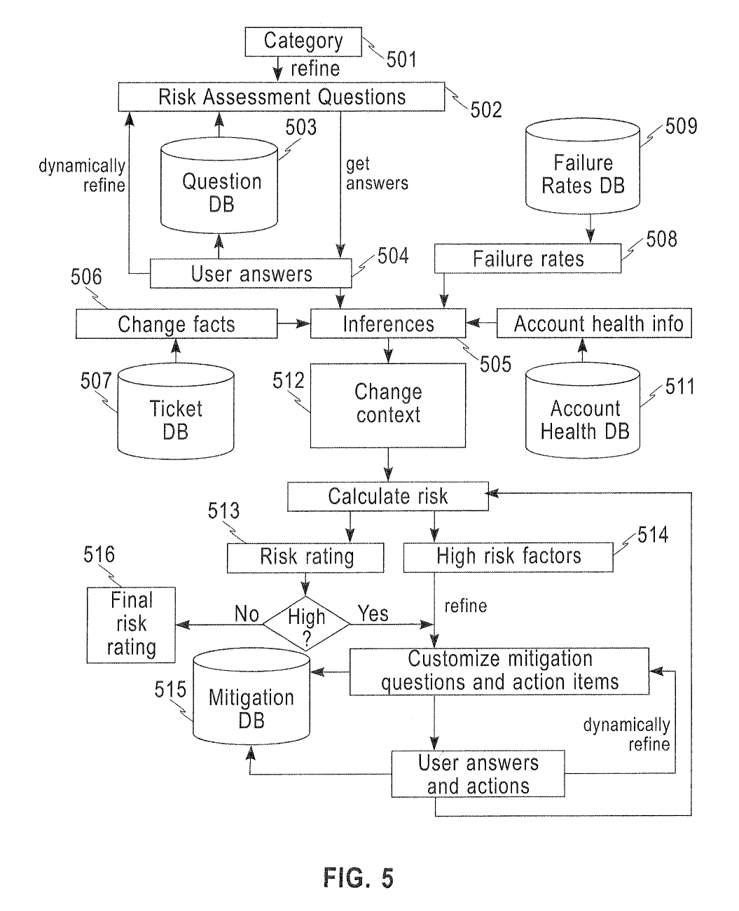

FIG. 5 shows the architecture of a risk engine according to an exemplary embodiment of the invention. As shown in FIG. 5, risk is determined based on a dynamic change context. A category 501 of a proposed change is input to the engine. An example of the category 501 could be upgrading a database, upgrading an OS, etc. The engine retrieves risk assessment questions 502 from a question database DB 503 based on the input category 501. The engine asks a user these risk assessment questions 502. Then, based on answers 504 to these questions 502, the questions 502 may be further refined if necessary. For example, some of the questions 502 may be filtered out that are rendered not relevant based on a user's previous answers. The refinement process may repeat a predetermined number of times until a final resultant set of questions 502 are produced.

Inferences 505 can then be drawn from user answers 504 to the resultant risk assessment questions 502, change facts 506 from a ticket database DB 507, failure rates 508 from a failure rates database 509, and account health information 510 from an account health DB 511. The change facts 506 may include, but are not limited to an exception reason for a change, the urgency of the change, the priority of the change, an indication of the presence of back-out plan. The failure rates 508 may be derived from historical information of similar changes. For example, the failure rates DB 509 could store a 10% failure rate for database upgrades and 20% failure rate for operating system upgrades. The failure rates may be associated with accounts that typically raise these changes. The account failure rates may be compared against all other accounts to get the failure rates.

The engine generates a change context 512 from the inferences 505. Using the change context 512, the engine determines risk to produce a risk rating 513 and identifies high risk factors 514 that contribute to the risk rating 513. The engine may store the high risk factors 514. Examples of the high risk factors 514 could include “missing back-out plan” and “high urgency”. For example, as part of installing a new version of a program, a back-out plan can save the old version. This way, if the install fails, the old version can be retrieved and re-installed. However, if such a back-out plan were missing, a failed installation would interrupt users, since no working versions of the program would be available. The high risk factors 514 may be used by change requesters to familiarize themselves with the potential risks they should look out for, as well as by the change managers during evaluation meetings as a checklist to discuss high risk changes.

The engine attempts to mitigate the high risk factors 514 to reduce the previously determined risk. The engine can be set to only mitigate risks that are above a predefined threshold value. As discussed above, the risk may be presented on a scale of 1-5. As an example, the engine may be set to mitigate whenever the determined risk is a 4 or a 5. The risk engine may refine a set of mitigation questions based on the high risk factors 514 identified during risk assessment and define any necessary user actions. The mitigation questions may be stored in a mitigation DB 514. The mitigations questions are designed to seek the required information or action to remedy the issue indicated in the high risk factors 414. For example, for a missing back-out plan, the mitigation action could be to add a back-out plan, or indicate that a back-out plan is not possible. This way, mitigation is done on the spot in real-time to reduce the discovered risks as much as possible. Depending on the change requester's answers to the mitigation questions and the actions they may take, the final risk rating 516 is determined. At the end of the mitigation routine, the (reduced) risk rating 516 is presented, along with any remaining high risk factors that could not be eliminated. Mitigating the risks identified during a documentation phase in this manner ensures that the change record is complete and has passed through several checks before it is presented to a Change Manager for evaluation. In addition, this process may ensure that changes reaching the evaluation phase are systematically assessed and correctly categorized.

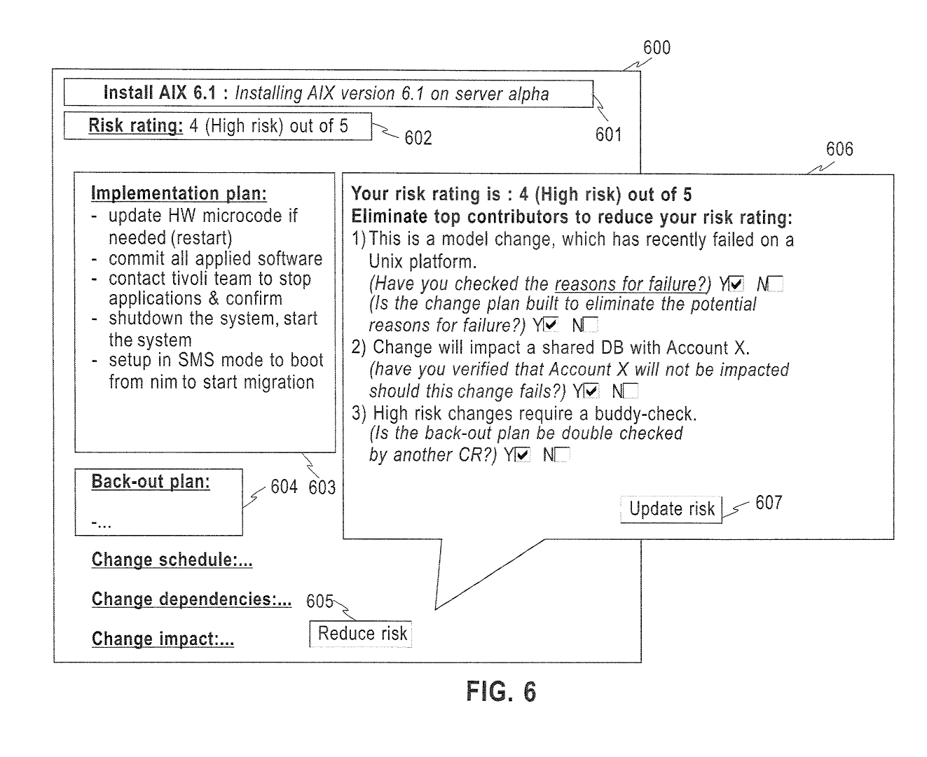

FIG. 6 illustrates an example of a window 600 that may be presented to an implementer of a change to mitigate the risk associated with that change. In FIG. 6, the proposed change 601 is for installing AIX version 6.1, an open standards-based UNIX operating system, on server Alpha and the corresponding assigned risk 602 is a ⅘. The window 600 further lists an implementation plan 603 for implementing the change and a back-out plan 604 for backing out the change. The window 600 includes a selectable mitigation button 605 that can be used to launch a mitigation window 606. The mitigation window 606 presents mitigation questions to a user based on the high risk factors 514 associated with the change. Once the mitigations questions have been answered, a selectable mitigation button 507 can be used to re-determine the risk based on the answers.

As discussed above, risk is determined based on a dynamic change context. Examples of account or process related issues that may affect the dynamic change context are lead time and change window. For example, a lead time is an account specific policy around how much time an account allocates for change preparation based on a risk rating. The higher the risk, the more lead time is needed. For example, a change window may include account specific work hours in which maintenance needs to be performed. In an alternate embodiment of the risk engine, the risk engine may propose actions to mitigate risk based on account policies. For example, the engine can be configured for account policies such as “If the risk is 5, mandate a lead time of 28 days and flag, and mitigate any implementation scheduled during work hours”.

Thus, in at least one embodiment of the invention, risk is assessed systematically without relying on any one person's opinion alone, dynamically by taking into account only the relevant pieces of information, and thoroughly by taking an entire context of a change into account, thereby increasing the assessment's accuracy. In addition, risk may be mitigated in real-time, since action items can be identified and offered to be taken to reduce the risk.

In an embodiment of the invention, the risk engine uses a set of one or more change context criteria to determine a set of risk assessment questions that are posed to determine a level of risk of a change at one or more steps of a design process. Some of the risk assessment questions may be determined from the change context criteria only while others of the questions may be determined from the change context criteria and human input.

Examples of the change context criteria include the type/category of the change, the number of users affected by the change, customer sites affected by the change, the end-user impact of the change, system elements affected by the change, service interruption requirements, number of resources required to implement change, resource competence, change window (e.g., how long will change run), change dependencies, change preparation efforts, change lead time (e.g., amount of time needed to prepare the change), change urgency, change priority, back-out plans, change execution environment (e.g., test, pre-test, production), change timeline (e.g., account work hours vs. maintenance hours), change impact on functionality, account change failure rates, company change failure rates, current account health, account health variation, missed SLAs, etc.

A graphical user interface may be provided to a change requester to enter change related information into a data structure associated with the change. The data structure may be referred to a change ticket and may be stored in the ticket DB 507 illustrated in FIG. 5. The change related information may include a description/summary of the change, a list of who will implement the change, a time/date when the change will be implemented, whether the change has a back-out plan, the urgency level of the change, the priority of the change, the reason for the change, the category/type of the change, etc.

The risk assessment questions are determined based on the category or type of the change and the engine determines a change context based on answers to the risk assessment question, facts from the change ticket associated with the change, account health information, previous failure rates, etc. The engine also draws inferences from all of this data. The change context is also used to determine a risk by assigning a weight and a risk rating to each element of the change context, such that each element is either a probability or an impact element. The combined result of all probabilities and impacts may be looked up against an Impact×Probability Matrix used in risk assessment. Table 1 below is an example of the Matrix.

TABLE 1

| Impact | Probability | Risk |
|---|---|---|
| 1 | 1 | 1 |
| 1 | 2 | 2 |
| 1 | 3 | 3 |
| 1 | 4 | 4 |
| 1 | 5 | 5 |
| 2 | 1 | 2 |
| 2 | 2 | 3 |
| 2 | 3 | 3 |
| 2 | 4 | 4 |
| 2 | 5 | 5 |
| 3 | 1 | 3 |
| 3 | 2 | 3 |
| 3 | 3 | 4 |
| 3 | 4 | 4 |
| 3 | 5 | 5 |
| 4 | 1 | 4 |
| 4 | 2 | 4 |
| 4 | 3 | 4 |
| 4 | 4 | 5 |
| 5 | 1 | 5 |
| 5 | 2 | 5 |

The risk determination process may yield a risk rating along with high risk factors that contribute to the risk. If the risk rating is high, the engine may use the high risk factors to automatically determine a list of mitigation questions and associated actions to reduce risk. If the risk is high, and a user opts for mitigation, the user can answer the mitigation questions and potentially takes actions to reduce the risk. Then a final risk rating may be generated and remaining list of high risk factors can be presented.

Examples of the risk assessment questions that may be asked to a user may include the following: How many users (including the account and their clients) would be impacted in the case of a change failure?; Does this change affect a local, multi-region, or a global service?; Would the failure of this change impact a critical service for the customer?; Would the failure of this change result in end-user calls to the Help Desk?; Would the execution of this change require a service interruption either during implementation or back-out?; How many resources are required to implement the change?; Does the resource need any training before the change can be implemented?; Is there enough time allocated in the change window to cover a potential back-out?; Does the change have any dependencies, or is it completely independent of other changes?; What is the preparation effort required for this change?, etc.

Examples of risk assessment questions whose answers may be automatically determined by the engine include the following: Does this change violate the lead time and therefore cause an exception?; What is the urgency of the change?; What is the change priority?; Is there a back-out plan?; Has a similar change been implemented previously by this particular resolver group?; Is this change going to be executed in a test or pre-production test environment, or the actual production environment?; Will the change be executed during a work hour change window, or outside work hours?; Is the change introducing new functionality or hardware?; Is the change modifying existing functionality or hardware?; Is the change introducing a new release of existing software?; What is the overall health score for the current month?; Is this a chronic/prechronic account or neither?; Is there a variation of the overall health score since last month?; What is the total number of missed SLAs?; What is the failure rate for the account for a change ticket with the same classification?; What is the failure rate for Pan IOT (mean of Pan IOT?) for the same classification?; Is the lead time less than the average lead time for a change ticket of the same classification?; Is the determined risk rating less than the average risk rating for a change ticket of a same classification?; Is the planned change duration less than the average change duration for a change ticket of a same classification?; etc.

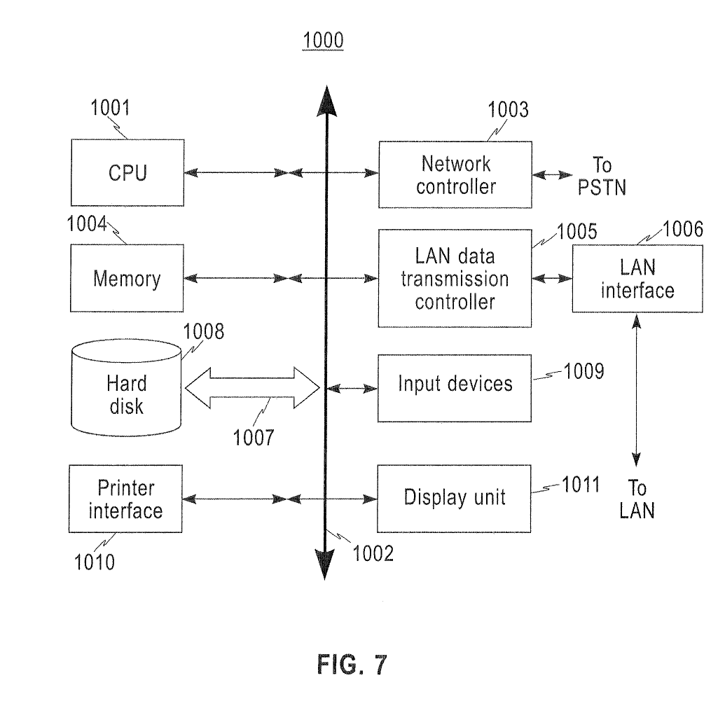

FIG. 7 illustrates an example of a computer system, which may execute any of the above-described methods or house any of the above-described risk engines, according to exemplary embodiments of the disclosure. For example, the methods of FIGS. 1-3 may be implemented in the form of a software application or computer program running on the computer system. For example, the risk category tree 400 of FIG. 4 or the risk engine of FIG. 5 may reside on the computer system. Examples of the computer system include a mainframe, personal computer (PC), handheld computer, a server, etc. The software application may be stored on a computer readable media (such as hard disk drive memory 1008) locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. For example, the display unit 1011 may display the above-described risk assessment questions, determined risks, mitigation questions, the user interface for entering the change ticket information, etc. As shown, the system 1000 may be connected to a data storage device, for example, a hard disk 1008, via a link 1007. For example, the hard disk 1008 may store each of the databases illustrated in FIG. 4, an impact×probability matrix, answers to the risk assessment and mitigation questions, change related information, etc. CPU 1001 may be the computer processor that performs the above described methods (e.g., those of FIGS. 1-3).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of determining risk associated with a proposed change, the method comprising:
entering change information related to the proposed change and a category of the change;
filtering, by a processor, risk assessment questions based on the entered category of the proposed change;
asking at least one of the filtered risk assessment questions to generate first answers;
automatically inferring, by the processor, second answers of at least one of the risk assessment questions based on the entered change information and historical information; and
determining, by the processor, the risk from weights assigned to each answer.

2. The method of claim 1, wherein the historical information includes failure rates of changes that are similar to the proposed change.

3. The method of claim 1, wherein the historical information includes health statistics of an account requesting the proposed change.

4. The method of claim 3, wherein the health statistics include a number of missed service level agreements.

5. The method of claim 1, wherein the entered information includes an urgency rating of the change.

6. The method of claim 1, wherein the entered information includes a back-out plan associated with the proposed change.

7. The method of claim 1, wherein the back-out plan includes steps to restore to a valid state that was present before the proposed change was implemented.

8. The method of claim 1, wherein the entered category is linked to a series of directions and the filtering comprises:
traversing a tree using the directions to arrive at a leaf node of a change category tree; and
selecting only the risk assessment questions associated with the leaf node.

9. The method of claim 1, wherein each risk assessment question is designed to predict a probability that the proposed change will fail.

10. The method of claim 1, wherein each risk assessment question is designed to predict the impact of the proposed change failing.

11. A method of mitigating a risk associated with a proposed change, the method comprising:
determining at least one high risk factor that is associated with a determined risk of a proposed change;
filtering mitigation risk questions based on the at least one high risk factors;
asking the filtered mitigation risk questions to generate mitigation answers;
determining a reduced risk from the mitigation answers and a change context of the proposed change.

12. The method of claim 11, wherein the change context is based on answers to risk assessment questions that indicate a level of risk of the proposed change.

13. The method of claim 12, wherein the change context is further based on failure rates for changes that are similar to the proposed change.

14. The method of claim 13, wherein the change context is further based on user entered information for the proposed change.

15. The method of claim 14, wherein the change context is further based on health statistics associated with an account requesting the proposed change.

16. The method of claim 15, wherein the health statistics include a number of missed service level agreements.

17. The method of claim 11, wherein determining the risk further comprises:
proposing at least one action item to an account requesting the change; and
reducing the risk based on completion of the action item.

18. An apparatus for assessing and mitigating risk of a proposed change, the apparatus comprising:
a memory storing a computer program to assess and mitigate risk, risk assessment questions, risk mitigation questions, and historical information associated with changes; and
a processor configured to execute the computer program,
wherein the computer program is configured to prompt entry of change information related to the proposed change and a category of the change, filter the risk assessment questions based on the entered category, prompt entry of first answers to at least one of the filtered risk assessment questions, infer second answers to at least one of the filtered risk assessment questions based on the change information and historical information, determine a risk based on the first and second answers, and mitigate the risk based on the risk mitigation questions.

19. The apparatus of claim 18, wherein the computer program mitigates the risk by determining high risk factors associated with the proposed change, filtering the mitigation questions based on the determined high risk factors, prompting for mitigation answers to the filtered mitigation questions, prompting for actions as determined by the filtered mitigation questions and re-determining the risk based on the actions taken and the mitigation answers, which define the change context dynamically.

20. The apparatus of claim 17, wherein the memory includes a database to store the risk assessment questions and the mitigation questions.

21. The apparatus of claim 17, wherein the historical information includes failure rates associated with changes that are similar to the proposed change.

22. The apparatus of claim 17, wherein the historical information includes a number of missed service level agreements of an account.

23. The apparatus of claim 17, wherein the memory stores a change category tree, and the input category is associated with a series of directions for traversing the tree to arrive at a leaf of the tree, and the filtered assessment questions are linked to the leaf.

24. A method of assessing and mitigating a risk of a proposed change, the method comprising:
entering a category of the change;
filtering, by a processor, risk assessment questions based on the entered category of the proposed change;
determining, by the processor, an initial risk based on answers to the filtered questions;
determining at least one high risk factor that is associated with the initial risk;
filtering mitigation risk questions based on the at least one high risk factors; and
re-determining, by the processor, the risk from mitigation answers to the filtered mitigation risk questions.

25. The method of claim 24, wherein the answers include at least one answer that is received directly from an account and at least one answer that is inferred from historical information associated with changes that are similar to the proposed change.
